(19) United States
(12) Patent Application Publication
(10) Pub. No.: US 2010/0007651 A1
(43) Pub. Date: Jan. 14, 2010

(54) PIXEL AND ORGANIC LIGHT EMITTING DISPLAY USING THE SAME

(76) Inventor: Yang-Wan Kim, Yongin-city (KR)

Correspondence Address: CHRISTIE, PARKER & HALE, LLP, PO BOX 7068, PASADENA, CA, 91109-7068, US

(21) Appl. No.: 12/495,729

(22) Filed: Jun. 30, 2009

Related U.S. Application Data
(60) Provisional application No. 61/079,018, filed on Jul. 8, 2008.

(51) Int. Cl. G06F 3/038; G09G 3/32

(52) U.S. Cl. 345/213; 345/82

(57) ABSTRACT

A pixel circuit coupled to a data line, a scan line, an emission control line, a power supply, a reference power source, and a light emitting element, includes: a data switch coupled between the data line and a first node, and having a control electrode coupled to the scan line; a reference switch coupled between the reference power source and a second node, and having a control electrode coupled to the scan line; a capacitor coupled between the first node and the second node; a driving transistor coupled between the power supply and the light emitting element, and having a gate electrode coupled to the second node; and an emission control switch coupled between the power supply and the first node, and having a control electrode coupled to the emission control line.

### CROSS-REFERENCE TO RELATED APPLICATIONS

This application claims priority to and the benefit of U.S. Provisional Patent Application No. 61/079,018, filed on Jul. 8, 2008, the entire content of which is incorporated herein by reference.

### BACKGROUND

1. Field

The following description relates to a pixel and an organic light emitting display using the same.

2. Discussion of Related Art

Recently, various flat panel display devices having light weight and smaller size when compared to cathode ray tubes have been developed. Such flat panel display devices include liquid crystal displays (LCDs), field emission displays (FEDs), plasma display panels (PDPs), and organic light emitting displays, among others.

Among these flat panel display devices, the organic light emitting display displays images by using organic light emitting diodes which generate light through the recombination of electrons and holes. Such organic light emitting diodes are driven with low power consumption and have rapid response times.

Generally, a pixel of an organic light emitting display device includes a storage capacitor that is charged with a voltage corresponding to a difference between a first power and a data signal, and displays a predetermined image by supplying a current corresponding to the charged voltage to the organic light emitting diode. Here, the first power is a voltage for supplying current to the pixels, and there is a relatively large voltage drop across the organic light emitting display device. Therefore, it is difficult to charge a desired voltage in the storage capacitor of different pixels due to the voltage drop of the first power supply, and a desired image cannot be displayed.

### SUMMARY OF THE INVENTION

Therefore, exemplary embodiments of the present invention provide a pixel for displaying a desired picture quality of an image, independent of a voltage drop and/or voltage ripple of a first power, and an organic light emitting display device using the same.

An exemplary embodiment of the present invention provides a pixel circuit coupled to a data line for transmitting a data signal, a scan line for transmitting a scan signal, an emission control line for transmitting an emission control signal, a power supply for supplying a power voltage, a reference power source for supplying a reference voltage, and a light emitting element, the pixel circuit including: a data switch coupled between the data line and a first node, and having a control electrode coupled to the scan line; a reference switch coupled between the reference power source and a second node, and having a control electrode coupled to the scan line; a capacitor coupled between the first node and the second node; a driving transistor coupled between the power supply and the light emitting element, and having a gate electrode coupled to the second node; and an emission control switch coupled between the power supply and the first node, and having a control electrode coupled to the emission control line.

Another exemplary embodiment of the present invention provides a method of driving a pixel including a light emitting element, the method including: charging a capacitor with a data voltage corresponding to a voltage difference between a data signal from a data line and a reference voltage from a reference power source; supplying a power voltage from a power supply to a source electrode of a driving transistor; and applying a driving voltage based on the data voltage and the power voltage to the gate electrode of the driving transistor; wherein the light emitting element is coupled to a drain electrode of the driving transistor, and wherein a driving current is generated and applied to the light emitting element in accordance with the driving voltage.

Another exemplary embodiment of the present invention provides an organic light emitting display including: a plurality of data lines for applying data signals; a plurality of scan lines for applying scan signals; a plurality of emission control lines for applying emission control signals; and a plurality of pixels defined at crossing regions of the plurality of data lines, the plurality of scan lines, and the plurality of emission control lines, each of the plurality of pixels including: a switching transistor for applying the data signal to the pixel in accordance with the scan signal; a reference transistor for supplying a reference voltage from a reference power source to the pixel in accordance with the scan signal; a capacitor for storing a data voltage corresponding to a voltage difference between the data signal and the reference voltage; an emission control transistor for supplying a power voltage from a power supply to a first terminal of the capacitor in accordance with the emission control signal, such that a second terminal of the capacitor is at a driving voltage corresponding to a voltage difference between the power voltage and the data voltage; a driving transistor for generating a driving current in accordance with the driving voltage; and a light emitting element for emitting light in accordance with the driving current.

Another exemplary embodiment of the present invention provides an organic light emitting display including a plurality of pixels, each of the plurality of pixels coupled to one of a plurality of data lines for transmitting a data signal, one of a plurality of scan lines for transmitting a scan signal, one of a plurality of emission control lines for transmitting an emission control signal, a first power supply for supplying a first power voltage, a second power supply for supplying a second power voltage, and a reference voltage source for supplying a reference voltage, each of the plurality of pixels including: a pixel circuit including a storage element for storing a first voltage corresponding to a voltage difference between the data signal and the reference voltage in accordance with the scan signal; and a light emitting element coupled between the pixel circuit and the second power supply; wherein a first terminal of the storage element is coupled to the first power supply in accordance with the emission control signal while a second terminal of the storage element is floating, such that the second terminal is at a second voltage corresponding to a voltage difference between the first power voltage and the first voltage, and wherein the light emitting element is configured to emit light in accordance with the second voltage.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 schematically illustrates an organic light emitting display device according to an embodiment of the present invention;

FIG. 2 illustrates a circuit diagram of an embodiment of a pixel of FIG. 1; and

FIG. 3 is a waveform view showing a method of driving the pixel of FIG. 2.

### DETAILED DESCRIPTION OF EXEMPLARY EMBODIMENTS

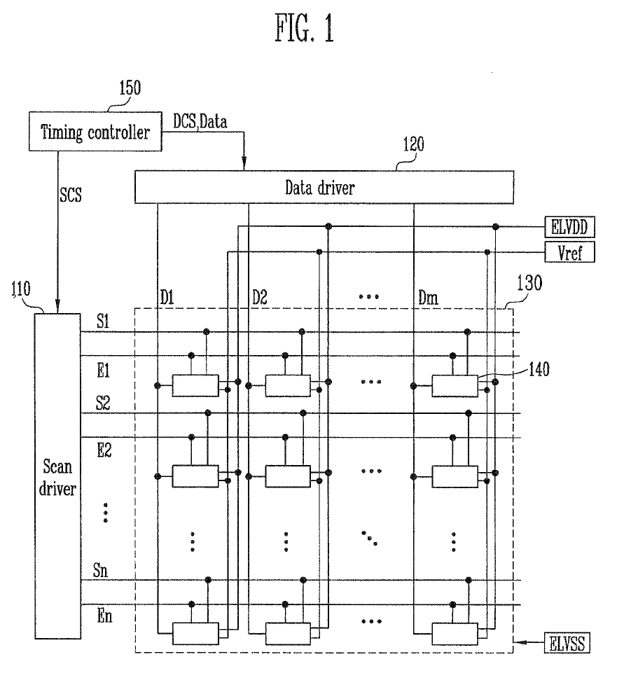

Hereinafter, exemplary embodiments of the present invention, that those skilled in the art to which the present invention pertains can easily carry out, will be described in further detail, with reference to the accompanying FIGS. 1 to 3.

FIG. 1 illustrates an organic light emitting display device according to an embodiment of the present invention.

Referring to FIG. 1, an organic light emitting display device according to an embodiment of the present invention includes a display region 130 including a plurality of pixels 140 coupled to scan lines S1 to Sn, light emission control lines E1 to En, and data lines D1 to Dm, a scan driver 10 for driving the scan lines S1 to Sn and the light emission control lines E1 to En, a data driver 120 for driving the data lines D1 to Dm, and a timing controller 150 for controlling the scan driver 110 and the data driver 120.

The display region 130 includes a plurality of pixels 140 positioned at crossing regions of the scan lines S1 to Sn and the data lines D1 to Dm. The pixels 140 receive a first power supply ELVDD, a second power supply ELVSS, and a reference voltage Vref from the outside (e.g., from a reference power source from the outside). The respective pixels supplied with the reference voltage Vref charge voltages corresponding to the reference voltage Vref and data signals in respective storage capacitors.

The respective pixels 140 supply a current corresponding to a voltage charged in the storage capacitor from the first power supply ELVDD to the second power supply ELVSS via an organic light emitting diode. Then, the organic light emitting diode generates light with a brightness (e.g., a predetermined brightness).

The timing controller 150 generates data driving control signals DCS and scan driving control signals SCS in accordance with synchronization signals supplied from the outside. The data driving control signals DCS generated in the timing controller 150 are supplied to the data driver 120, and the scan driving control signals SCS are supplied to the scan driver 110. The timing controller 150 also supplies data (Data) supplied from the outside to the data driver 120.

The scan driver 110 receives the scan driving control signals SCS, and sequentially supplies scan signals (e.g., low-level voltages) to the scan lines S1 to Sn. The scan driver 110 sequentially supplies light emission control signals (e.g., high-level voltages) to the light emission control lines E1 to En. Here, a light emission control signal supplied to an i-th (i is a natural number) light emission control line E1 overlaps with a scan signal supplied to an i-th scan line Si.

The data driver 120 receives the data driving control signals DCS from the timing controller 150. The data driver 120 generates data signals and supplies the generated data signals to the data lines D1 to Dm.

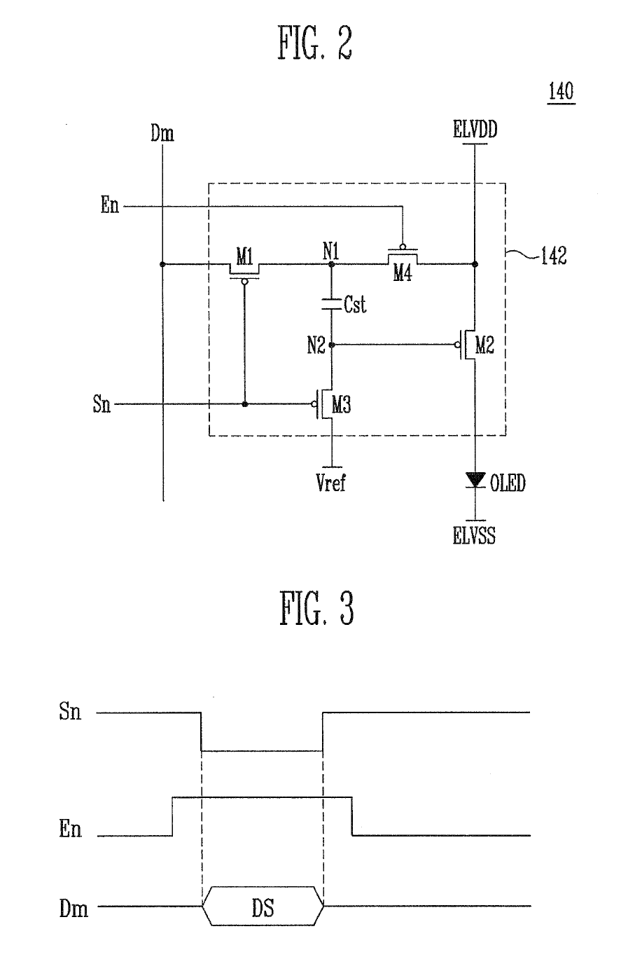

FIG. 2 illustrates a circuit diagram of an embodiment of the pixel of FIG. 1. For convenience of explanation, FIG. 2 shows a pixel coupled to an n-th scan line Sn and an m-th data line Dm.

Referring to FIG. 2, a pixel 140 of the embodiment of the present invention includes an organic light emitting diode OLED and a pixel circuit 142 for supplying a current to the organic light emitting diode OLED.

The organic light emitting diode OLED generates a color of light corresponding to a current supplied from the pixel circuit 142. For example, the organic light emitting diode OLED generates red, green, or blue light having a brightness (e.g., a predetermined brightness) in accordance with an amount of current supplied from the pixel circuit 142.

The pixel circuit 142 charges a voltage corresponding to a reference voltage Vref and a data signal, and supplies a current corresponding to the charged voltage to the organic light emitting diode OLED. To this end, the pixel circuit 142 includes first to fourth transistors M1 to M4 and a storage capacitor Cst.

A first electrode of the first transistor M1 is coupled to a data line Dm, and a second electrode thereof is coupled to a first node N1. A gate electrode of the first transistor M1 is coupled to a scan line Sn. The first transistor M1 is turned on when a scan signal is supplied to the scan line Sn, and electrically couples the data line Dm to the first node N1.

A first electrode of the second transistor M2 is coupled to a first power supply ELVDD, and a second electrode thereof is coupled to an organic light emitting diode OLED. A gate electrode of the second transistor M2 is coupled to a second node N2. The second transistor M2 supplies a current corresponding to a voltage applied to the second node N2, that is, a voltage corresponding to the voltage charged in a storage capacitor Cst, to the organic light emitting diode OLED.

A first electrode of the third transistor M3 is coupled to the second node N2, and a second electrode thereof is coupled to a reference voltage Vref. A gate electrode of the third transistor M3 is coupled to the scan line Sn. The third transistor M3 is turned on when a scan signal is supplied to the scan line Sn to electrically couple the reference voltage Vref to the second node N2.

A first electrode of the fourth transistor M4 is coupled to the first power supply ELVDD, and a second electrode thereof is coupled to the first node N1. A gate electrode of the fourth transistor M4 is coupled to a light emission control line En. The fourth transistor M4 is turned on when a light emission control signal is supplied, and is turned off when the light emission control signal is not supplied. The light emission control signal substantially overlaps with a scan signal, and thus the fourth transistor M4 is turned off during the period of charging a voltage (e.g., a predetermined voltage) in the storage capacitor Cst, and is turned on during periods other than this charging period.

A first terminal of the storage capacitor Cst is coupled to the first node N1, and a second terminal thereof is coupled to the second node N2. A voltage corresponding to a difference between the reference voltage Vref and the data signal is charged in the storage capacitor Cst. To this end, the data signal is set to be equal to or higher than the reference voltage Vref. The data signal is set to be lower than the first power supply ELVDD.

Meanwhile, the first power supply ELVDD is coupled to the respective pixels 140 for supplying current thereto, and thus different voltage drops occur according to the positions of the pixels 140 in the display region 130. However, the reference voltage Vref does not supply current to respective pixels 140, thereby maintaining a substantially same voltage value independent of the position of the pixels 140.

FIG. 3 is a waveform view showing a method of driving the pixel of FIG. 2. Referring to FIG. 3, first a light emission control signal is supplied to a light emission control line En, so that the fourth transistor M4 is turned off. Thereafter, a scan signal is supplied to a scan line Sn, so that first transistor M1 and third transistor M3 are turned on.

When the first transistor M1 is turned on, a data signal DS is supplied from the data line Dm to the first node N1. When the third transistor M3 is turned on, a voltage from the reference voltage Vref is supplied to the second node N2. At this time, a voltage corresponding to a difference between the reference voltage Vref and the data signal is charged in the storage capacitor Cst.

Here, the voltage is charged in the storage capacitor Cst independent of the first power supply ELVDD. Thus, the voltage charged in the storage capacitor Cst is set independent of a voltage drop of the first power supply ELVDD. After a voltage (e.g., a predetermined voltage) is charged in the storage capacitor Cst, the supply of the scan signal and light emission control signal is suspended.

When the supply of the scan signal to the scan line Sn is suspended, the first transistor M1 and third transistor M3 are turned off. When the supply of the light emission control signal to the light emission control line En is suspended, the fourth transistor M4 is turned on.

When the fourth transistor M4 is turned on, a voltage from the first power supply ELVDD is supplied to the first node N1. At this time, the second node N2 is set to be in a floating state, and thus a voltage of the second node N2 changes corresponding to voltage variations of the first node N1, thereby compensating for voltage drops in the first power supply ELVDD.

More specifically, as a voltage of the first power supply ELVDD, which may be subject to a voltage drop, increases, the voltage increase at the first node N1 may also increase when the fourth transistor M4 is turned on. For example, if a voltage of the first power supply ELVDD is 5V and a voltage at the first node N1 is 3V in a first pixel, the voltage increase at the first node N1 of the first pixel amounts to 2V. If a voltage of the first power supply ELVDD is 4V and a voltage of the first node N1 is 3V in a second pixel, the voltage increase at the first node N1 of the second pixel amounts to 1V.

In this case, a voltage between the gate electrode and the source electrode of the second transistor M2 can be kept substantially constant between pixels, independent of the voltage drop of the first power supply ELVDD, thereby compensating for the voltage drop of the first power supply ELVDD. In other words, a voltage applied to the gate electrode of the second transistor M2 (in case of a same data signal) reduces as the voltage drop of the first power supply ELVDD increases, thereby compensating for the voltage drop of the first power supply ELVDD.

Meanwhile, even if a voltage of the first node N1 changes due to ripples of the first power supply ELVDD, a voltage charged in the storage capacitor Cst also does not change, but is kept at a substantially constant voltage. For example, when a voltage of the first node N1 rises by means of a ripple of the first power supply ELVDD, a voltage of the second node N2 also rises correspondingly, thereby maintaining a constant voltage independent of the ripple of the first power supply ELVDD, and preventing occurrences of a flicker phenomenon accordingly.

As described above, with a pixel and an organic light emitting display device using the same according to exemplary embodiments of the present invention, a desired voltage can more readily be charged in a storage capacitor by utilizing a reference voltage and a data signal. A voltage of a gate electrode of a driving transistor may be adjusted to compensate for a voltage drop of a first power supply, for more readily displaying a desired picture quality of an image. Furthermore, a first terminal of the storage capacitor of the pixels is coupled to the first power supply and a second terminal of the storage capacitor is coupled to the gate electrode of the driving transistor for displaying an image with a desired quality independent of ripples of the first power supply.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. A pixel circuit coupled to a data line for transmitting a data signal, a scan line for transmitting a scan signal, an emission control line for transmitting an emission control signal, a power supply for supplying a power voltage, a reference power source for supplying a reference voltage, and a light emitting element, the pixel circuit comprising:
a data switch coupled between the data line and a first node, and having a control electrode coupled to the scan line;
a reference switch coupled between the reference power source and a second node, and having a control electrode coupled to the scan line;
a capacitor coupled between the first node and the second node;
a driving transistor coupled between the power supply and the light emitting element, and having a gate electrode coupled to the second node; and
an emission control switch coupled between the power supply and the first node, and having a control electrode coupled to the emission control line.

2. The pixel circuit of claim 1, wherein the data switch is configured to transmit the data signal to the first node in accordance with the scan signal, the reference switch is configured to supply the reference voltage to the second node in accordance with the scan signal, the capacitor is configured to store a data voltage corresponding to a voltage difference between the data signal and the reference voltage, the emission control switch is configured to supply the power voltage to the first node in accordance with the emission control signal such that the second node is at a driving voltage corresponding to a voltage difference between the power voltage and the data voltage, and the driving transistor is configured to transmit a driving current to the light emitting element in accordance with the driving voltage.

3. The pixel circuit of claim 1, wherein the data signal is initially stored in the capacitor independent of the power voltage.

4. The pixel circuit of claim 1, wherein the data signal has a voltage level that is higher than the reference voltage and lower than the power voltage.

5. The pixel circuit of claim 1, wherein the data switch and the reference switch are configured to turn on concurrently, and wherein the emission control switch is configured to be turned off when the data switch and the reference switch are on.

6. The pixel circuit of claim 1, wherein the second node is floating when the emission control switch is on.

7. The pixel circuit of claim 1, wherein the light emitting element is configured to generate red, green, or blue light, and wherein the brightness of the red, green, or blue light generated by the light emitting element is determined by the driving current.

8. A method of driving a pixel comprising a light emitting element, the method comprising:
charging a capacitor with a data voltage corresponding to a voltage difference between a data signal from a data line and a reference voltage from a reference power source;
supplying a power voltage from a power supply to a source electrode of a driving transistor; and
applying a driving voltage based on the data voltage and the power voltage to the gate electrode of the driving transistor;
wherein the light emitting element is coupled to a drain electrode of the driving transistor, and
wherein a driving current is generated and applied to the light emitting element in accordance with the driving voltage.

9. The method of claim 8, wherein the charging the capacitor comprises:
applying the data signal to a first terminal of the capacitor through a data switch in accordance with a scan signal from a scan line; and
supplying the reference voltage to a second terminal of the capacitor through a reference switch in accordance with the scan signal.

10. The method of claim 9, wherein the data switch and the reference switch are concurrently turned on and off.

11. The method of claim 8, further comprising supplying the power voltage to the first terminal of the capacitor by turning on an emission control switch in accordance with an emission control signal from an emission control line.

12. The method of claim 11, wherein the second terminal of the capacitor is floating when the power voltage is supplied to the first terminal of the capacitor, such that the driving voltage corresponds to a voltage difference between the power voltage and the data voltage.

13. The method of claim 11, wherein the emission control switch is off during the charging the capacitor, such that the data voltage is charged independent of the power voltage.

14. An organic light emitting display comprising:
a plurality of data lines for applying data signals;
a plurality of scan lines for applying scan signals;
a plurality of emission control lines for applying emission control signals; and
a plurality of pixels defined at crossing regions of the plurality of data lines, the plurality of scan lines, and the plurality of emission control lines, each of the plurality of pixels comprising:
a switching transistor for applying the data signal to the pixel in accordance with the scan signal;
a reference transistor for supplying a reference voltage from a reference power source to the pixel in accordance with the scan signal;
a capacitor for storing a data voltage corresponding to a voltage difference between the data signal and the reference voltage;
an emission control transistor for supplying a power voltage from a power supply to a first terminal of the capacitor in accordance with the emission control signal, such that a second terminal of the capacitor is at a driving voltage corresponding to a voltage difference between the power voltage and the data voltage;
a driving transistor for generating a driving current in accordance with the driving voltage; and
a light emitting element for emitting light in accordance with the driving current.

15. The organic light emitting display of claim 14, wherein the reference voltage is substantially the same for each of the plurality of pixels.

16. The organic light emitting display of claim 14, wherein the switching transistor and the reference transistor are configured to turn on and off concurrently.

17. The organic light emitting display of claim 16, wherein the emission control transistor is configured to turn off when the switching transistor and the reference transistor are on, so that the data voltage is charged in the capacitor independent of the power voltage.

18. The organic light emitting display of claim 14, wherein the data signal has a voltage level that is higher than the reference voltage and lower than the power voltage.

19. The organic light emitting display of claim 14, wherein the second terminal of the capacitor is floating when the emission control transistor is on to determine the driving voltage.

20. An organic light emitting display comprising a plurality of pixels, each of the plurality of pixels coupled to one of a plurality of data lines for transmitting a data signal, one of a plurality of scan lines for transmitting a scan signal, one of a plurality of emission control lines for transmitting an emission control signal, a first power supply for supplying a first power voltage, a second power supply for supplying a second power voltage, and a reference voltage source for supplying a reference voltage, each of the plurality of pixels comprising:
a pixel circuit including a storage element for storing a first voltage corresponding to a voltage difference between the data signal and the reference voltage in accordance with the scan signal; and
a light emitting element coupled between the pixel circuit and the second power supply;
wherein a first terminal of the storage element is coupled to the first power supply in accordance with the emission control signal while a second terminal of the storage element is floating, such that the second terminal is at a second voltage corresponding to a voltage difference between the first power voltage and the first voltage, and
wherein the light emitting element is configured to emit light in accordance with the second voltage.
